(19) United States
(12) Patent Application Publication
(10) Pub. No.: US 2007/0119319 A1
(43) Pub. Date: May 31, 2007

(54) Cylinder for receiving a printing form

(76) Inventors: Jan Thorsten Weber, Lengerich (DE); Jurgen Vutz, Greven (DE); Heinfried Hinrichsmeyer, Ostercappeln (DE); Dietmar Potter, Westerkappeln (DE)

Correspondence Address: JACOBSON HOLMAN PLLC, 400 SEVENTH STREET N.W., SUITE 600, WASHINGTON, DC, 20004, US

(21) Appl. No.: 10/586,248

(22) PCT Filed: Jan. 14, 2005
(86) PCT No.: PCT/EP05/00353

§ 371 Date: Jul. 17, 2006

(30) Foreign Application Priority Data
Jan. 15, 2004 (DE) 10 2004 002 383.2

(51) Int. Cl. B41F 13/10

(52) U.S. Cl. 101/375

(57) ABSTRACT

Disclosed is a cylinder (1) for the receptacle of a printing form, which (1) is rotatable about its principal symmetry axis during a printing operation and which (1) comprises at least one first sleeve (20), which (20) contains carbon fiber reinforced plastic.

The novelty and inventive step lies in that the majority of the carbon fibers in the plastic are aligned essentially parallel to the principal symmetry axis of the cylinder (1). The method of the production of a cylinder according to the invention is also claimed.

The invention relates to a cylinder for the receptacle of a printing form according to the preamble of the claim 1.

This type of printing cylinders, which comprise a sleeve made from carbon fiber reinforced plastic (CFRP), are known since a long time. All these sleeves are produced by winding carbon fibers around a mandrel in a winding machine and are embedded in a plastic matrix. One such device is described in U.S. Pat. No. 4,359,356.

A patent was granted last time for a printing cylinder described in EP 1025996 B1, which also comprised a sleeve with this type of wound frame. The advantages of this cylinder are well-known to specialists familiar with the prior art for quite some time. The light weight and high bending strength of the CFRP facilitate the handling of the cylinder during the replacement of the forms, as well as lead to good printing quality. A preferred field of application of this printing cylinder is in the flexographic printing. However, against the exclusive use of this cylinder counterweigh the high costs of the CFRP sleeves. Thus, the costs of a CFRP printing cylinder are often higher by a factor of 10 compared to an aluminum cylinder of the same size. These costs are a consequence of the high prices of the carbon fibers as well as of the longer exposure of the costly winding machine.

Therefore the object of the present invention is to propose a cylinder for the receptacle of a printing form, which comprises a more economical sleeve with the same or better bending strength.

This problem is solved through the characterizing part of the claim 1.

In all the sleeves according to the state-of-the-art, the carbon fibers are arranged at a large angle with respect to the principal symmetry axis of the sleeve and hence in general with respect to the printing cylinder. The improvement in the bending strength of the sleeve by using tensile stress resistant carbon fibers is optimal in that case, if the carbon fibers are aligned parallel to the principal symmetry axis of the sleeve. The same bending strength of the sleeve, with less carbon fiber, which can be wound in lesser time, can thus be realized. Production of such sleeves, which contain fibers that are parallel or nearly parallel to the axis, can be achieved, for example, with devices, like those described in U.S. Pat. No. 5,213,275 or U.S. Pat. No. 5,468,329.

Preferable is however production of sleeves with a so-called pultrusion method that is similar to strand extrusion. In that method, it is possible to align the carbon fibers with an orientation that is parallel to the axis for the most part in the plastic matrix, still viscuous, and already during the pultrusion process. The extrusion of the plastic carbon fiber mixture takes place in general by means of an extrusion tool, and the fibers are often drawn out further by means of a drawing device. The plastic matrix hardens into a sleeve or into a pipe that can be separated into individual sleeves.

Other extrusion methods also come in question, because long carbon fibers can in general be aligned by using an appropriate method. With adequate output using this method, further cost advantages can be achieved.

However, due to the relatively uniform alignment along the principal symmetry axis of the sleeve, which is a consequence of the method of production, other disadvantages can also arise. If the sleeve is subjected to torsional stresses—to which it can be exposed, for example, during a change in the speed—one finds, that the fibers with axially parallel alignment can contribute less to the absorption of the torsional stress compared to fibers which are inclined at an appreciable angle with respect to the axis.

Therefore it is of advantage to equip the printing cylinder with additional means for taking off this torsional stress.

Such devices for absorbing the torsional stress are in general mechanically connected with the first sleeve. Thus a meshwork or a web made from a material that is capable of taking tensile load can be employed—preferably glued—on the outer circumferential areas of the sleeve. The material capable of taking tensile load can be CFRP, GFRP or even a wire. It is often an advantage, if the printing cylinder comprises an additional sleeve. It is especially of advantage, if this additional sleeve can take over the function of the means for absorbing the torsional stress. In that case, this additional sleeve can be produced with methods of production other than those used for the first sleeve. Thus a first sleeve produced with pultrusion method can be meaningfully supplemented with a second sleeve wound diagonally with respect to the first sleeve. Even when an additional second sleeve made from CFRP is wound on a first sleeve produced with the pultrusion method, the cost benefits compared to an exclusively wound sleeve are preserved, because the forces of torsion acting on the printing cylinder are as a rule smaller than those due above all to the own weight of the cylinder and the bending forces that cause the tension in the sheet. Thus a smaller number of additionally winded CFRP is enough to compensate for the forces of the torsion.

However, due to the costing situation described at the outset, use of GFRP (glass fiber reinforced plastic) or recourse to a metallic sleeve is commendable at this place. The connection between the different sleeves will be in general a close interior, planar connection. For the connection, adhesives, and additionally, in particular in metallic sleeves, shrinking methods are employed. Even if an additional sleeve is made on the first sleeve with the winding method, this additional sleeve remains an additional sleeve in the sense of this application, even if it is made of the same plastic and/or carbon fiber materials as the first sleeve.

Majority of the carbon fibers can be interpreted to mean more than 50, 80, 90 or 95%. However, what is meant with this denotation is that the fibers in the first sleeve are produced with a production method, which enables such an alignment. Among such methods belong the pultrusion and extrusion methods. However, other winding methods are also known, which enable an alignment of the fibers that is nearly parallel to the axis. Thus this alignment can be achieved, among other things, in that in the winding method, a mandrel is provided at the ends of the front side, which hold the fibers at that front side.

In regard to the devices for absorbing the torsional stress, one must emphasize that, besides the use of additional sleeves, use of rings is also possible. Such rings can encircle the first sleeve or can be arranged within it. Since the outer area of the printing plate cylinder must be plane on the whole, it is preferable to arrange the rings in the inner surface areas. The rings can be made from a metal like steel or from a plastic or plastic-composite material like the aforementioned materials. They can also be connected with the first sleeve like the other sleeves (through gluing, shrinking etc.).

To reduce the weight, such rings can have a hollow form. A metal ring can, for example, be “undercut” from within, so that its cross sectional area (in its axial and radial plane) is u-shaped.

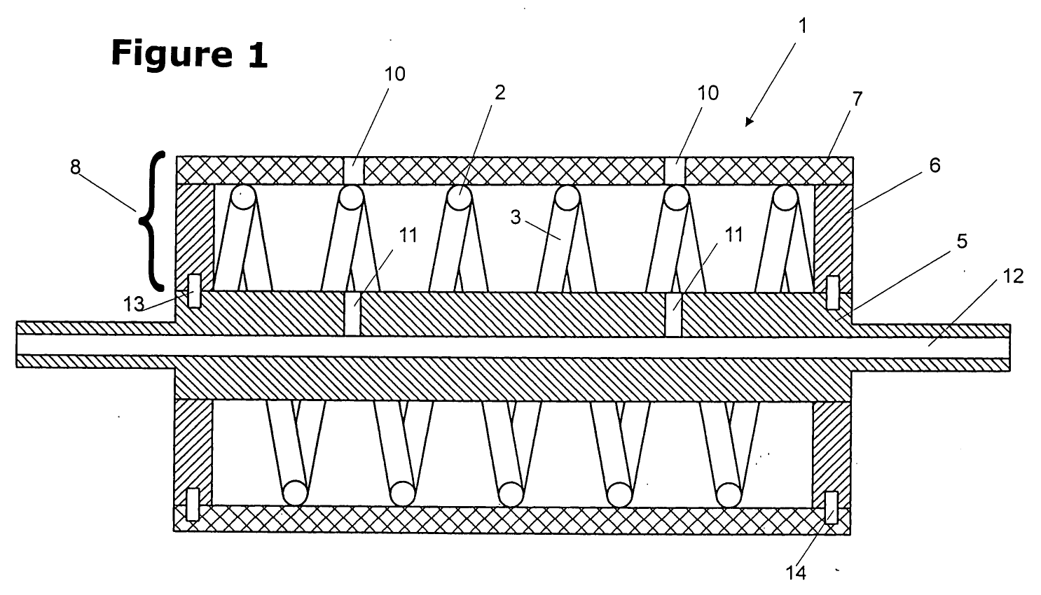

FIG. 1 A longitudinal cross section of a printing cylinder according to the invention

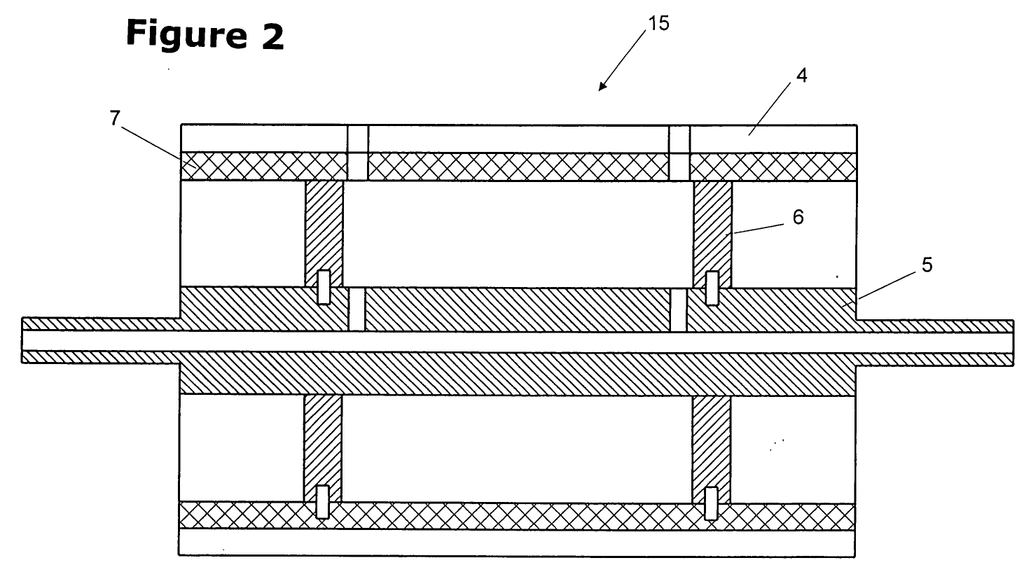

FIG. 2 A longitudinal cross section of a second printing cylinder according to a modified exemplary embodiment

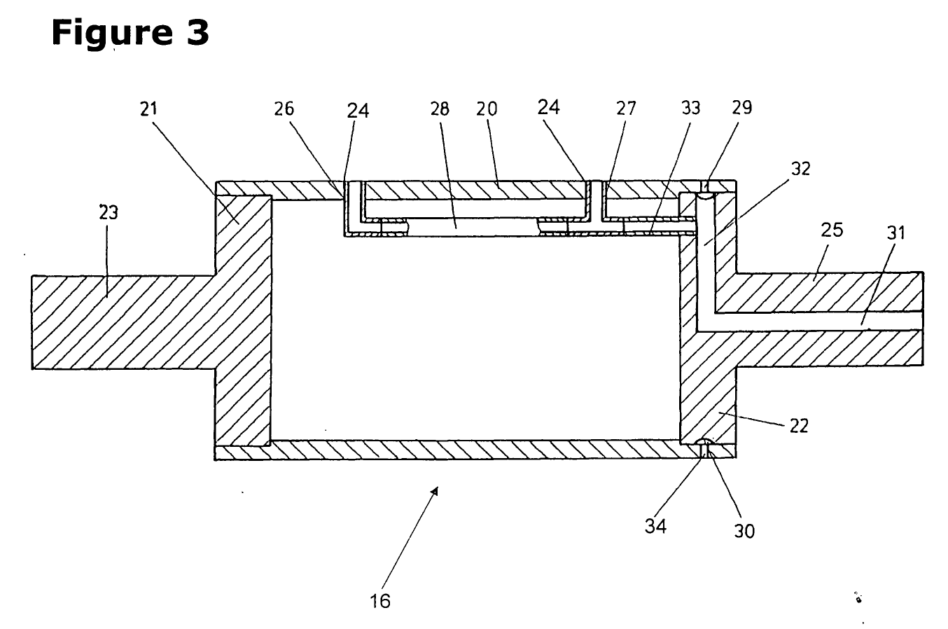

FIG. 3 A longitudinal cross section of a third printing cylinder according to a modified exemplary embodiment

FIG. 1 shows a printing cylinder 1, which comprises, among other things, a mandrel 5 and an adapter 8. Mandrel 5 is an fixed component of the printing machine and is connected either directly or through a gear mechanism with its drive and is mounted rotatably on the machine frame. Thereby it is supported above all at one end in the case of small printing widths, in the case of larger printing machines, one end is often fixed and the other is mounted in a manner that can be detached quickly. In this manner, the adapter 8, which comprises, in this exemplary embodiment, the sleeve 7, fiber 3 and the disks 6, is pulled over the free end of the mandrel 5. The adapter 8 is replaced if the printing length to be achieved with the printing cylinder 1 is to be changed. Such changes in the printing length are more frequently necessary, among others, in flexographic and intaglio printing. This is the case in particular, if the means of the packaging, such as film sheets or cartons for beverages, are to be printed with this printing method, because formats in widest varieties are used in packaging goods.

In the flexographic printing, it is usual to impinge on the outer periphery of the adapter with a flexible printing form. Thereby, a flat printing block, which is pasted, or a sleeve, which carries a flexible printing design, and is on its part drawn over the adapter 8, may be used. Neither the sleeve, nor the printing block is shown here. A sleeve can be drawn over the adapter mounted on the mandrel—that is, on the equipped—adapter, by impinging on the openings 10 in the sleeve 7 from the inside of the printing cylinder 1 with pressure—preferably in the form of compressed air. In which case, the sleeve, which is essentially flexible, can be drawn over the outer area of the printing cylinder 1. After this process, the pressure can be reduced, so that the sleeve assumes a tight fit. The printing medium can be fed through the canal 12 and the openings 11 in the mandrel 5 in the interior of the printing cylinder 1.

Usual practice is to fasten the adapter 8 in rotation-proof manner on the mandrel 5. This can be done in many different ways. Known are the use of clamps with wedges, shrinking through heating and subsequent cooling of the disks 6, clamping of the hydraulic and pneumatic expansion chuck sleeves etc. The fastening elements 13, 14 indicate such alternatives for these methods of fastening. The fastening elements 13 fasten the disks 6 on the mandrel 5. In this manner, the entire adapter, containing the rings 6, the sleeve 7 and the fiber 3 can be fastened on the mandrel or detached from it. In contrast to that, the fastening elements 14 are in the “wrong place,” because with them, only the sleeve 7 can be detached from the rings 9. The fastening elements 14 are therefore only meant to indicate here that besides the classical adapter solution, in which the rings 6 and sleeve 7 are detached at the same time, other alternatives are also thinkable. In general it will not be possible to provide both the fastening elements 13 as well as 14 on the printing cylinder 1.

FIG. 2 shows another, very similar printing cylinder 14. The differences lie in the disks 6 that are indented towards the axial ends of the printing cylinder 15 and the additional sleeve 4, which encircles the sleeve 7. This printing cylinder 15 can be used in the same manner as the printing cylinder 1.

FIG. 3 shows another printing cylinder 16 according to the invention, in which the mandrel 5 is dispensed with. Accordingly, the printing cylinder 1 is often denoted as a roller. The first sleeve 20, which also holds the carbon fibers in alignment in the manner according to the invention, is mounted on the axle journals 23, 25 by means of the end-side disks 21 and 22. Compared to the cylinders shown in the other figures, this cylinder employs yet another type of supply of the compressed air for detaching the sleeves, which are often used in flexographic printing as a carrier of the printing design. The compressed air is supplied to the recesses 24 via the canals 31 and 32 through the axle journal 25 and the pipe and pipe segments 28, 26, 27 and 33. The recess 34 receives its air via a canal 30, which runs around the circumference of the disk 22.

The shown type of air supply is however not a subject matter of the present invention, which has already been described adequately in DE 19846677 A1 and need not be discussed here further in greater detail.

Against that, of major importance are the devices 2, 3, 4 for absorbing the torsional stress, which are shown in the different figures. In FIG. 1, the cross sections 2 of the fibers 3 are shown. These fibers 3 are mounted on the inner side of the first sleeve 20. They are shown in the figure to give a rough illustration and are not to scale. They are suitable for absorbing the torsional stress. They can be of CFRP or GFRP fibers as well as of metal wires. Coarse metal spirals or bearing rings can also be hold the roller of the fibers. The fibers 3 extend along the inner wall of the first sleeve 20 and are thus, seen from the viewpoint of the onlooker, behind the mandrel 5. In FIG. 1, the fibers were wound in helical or screw-like form along the inner diameter of the sleeve 7. In this context, it is perhaps better to have several windings with different setting angles with respect to the axis of the cylinder 1. Naturally, when using fibers, it is rather common to provide the fibers with a plastic matrix. In which case, again one more sleeve 4 comes into play. Meshes of fibers, such as carbon fibers, can be mounted on the first sleeve 7 and can be used with advantage. If, as mentioned, rings are used there, it is of advantage, if these rings have, for instance, u-shaped cross sections, made using a lathe. It is apparently of greatest advantage, if the opening of the u-profile is oriented in the direction of the principal symmetry axis of the printing cylinder 1. The turning of the rings is obviously more suitable with metallic rings above all.

In FIG. 2, another sleeve 4 is mounted on the first sleeve 20, which serves the purpose, in this exemplary embodiment, also of a device for absorbing the torque. Another sleeve can also be mounted at the inner diameter of the first sleeve 20.

In FIG. 3 also, a sleeve 20, with axially parallel fibers not shown in the figure, is shown. Illustration of an additional sleeve 4 or some other device for absorbing the torsional stress is omitted here.

List of Reference Symbols

| | |
|---|---|
| 1 | Printing cylinder |
| 2 | Cross section of the fiber |
| 3 | Fiber |
| 4 | Other sleeves |
| 5 | Mandrel |
| 6 | Disks |
| 7 | Sleeve |
| 8 | Adapter |
| 9 | |
| 10 | Openings in the sleeve 7 |
| 11 | Openings in the mandrel 5 |
| 12 | Canal in mandrel 5 |
| 13 | Fastening elements between the mandrel and the disks |
| 14 | Fastening elements between the disks and the sleeves |
| 15 | Printing cylinder in FIG. 2 |
| 16 | Printing cylinder/roll in FIG. 3 |
| 20 | Sleeve |
| 21 | Disk |
| 22 | Disk |
| 23 | Axle journal |
| 24 | Recess |
| 25 | Axle journal |
| 26 | Pipe/Pipe segment |
| 27 | Pipe/Pipe segment |
| 28 | Pipe/Pipe segment |
| 30 | Canal |
| 31 | Canal |
| 32 | Canal |
| 33 | Pipe/Pipe segment |
| 34 | Recess |

1. Cylinder (1) for receptacle of a printing form, which (1) is rotatable about its principal symmetry axis during a printing operation and which (1) comprises at least one first sleeve (20), which (20) contains carbon fiber reinforced plastic, characterized in that the majority of the carbon fibers in the plastic are aligned essentially parallel to the principal symmetry axis of the cylinder (1).

2. Cylinder according to claim 1, characterized in that the angular deviation between the principal symmetry axis of the cylinder (1) and the majority of the carbon fibers is less than 10°.

3. Cylinder according to claim 2, characterized in that the angular deviation between the principal symmetry axis of the cylinder (1) and the majority of the carbon fibers is less than 5°.

4. Cylinder according to claim 1, characterized in that the angular deviation between the principal symmetry axis of the cylinder (1) and the majority of the carbon fibers is less than 2°.

5. Cylinder according to claim 1, characterized in that the first sleeve (20) contains pultroded carbon fiber reinforced plastic.

6. Cylinder according to claim 1, characterized in that devices for absorbing the torsional stress (2, 3, 4), which are so arranged that they absorb at least a part of the torsional stress, which acts on the first sleeve particularly during a change in the speed.

7. Cylinder according to claim 1, characterized in that there is at least one more sleeve (4), which is produced with a different method, and/or an alternative material.

8. Cylinder according to the preceding claim, characterized in that the additional sleeve (4) is made of a plastic composite material.

9. Cylinder according to the preceding claim, characterized in that plastic composite material of the additional sleeve (4) is a wound or spun CFRP or GFRP.

10. Cylinder according to the preceding claim, characterized in that the additional sleeve (4) is made of metal.

11. Cylinder according to claim 1, characterized in that at least one of the first sleeves (20) and the additional sleeves (4) are connected with each other, whereby the external circumferential area of one of the two sleeves (4, 20) and the internal circumferential area of the other sleeve (4, 20) are connected.

12. Cylinder according to claim 10, characterized in that the connection consists a substance capable of adhesion.

13. Cylinder according to claim 1, characterized in that the length of the majority of the carbon fibers in the first sleeve (20) lies in the range between 90 and 100% of the length of the first sleeve (20).

14. Cylinder according to claim 1, characterized in that the length of the majority of the carbon fibers in the fist sleeve (20) lies in a range between 95% and 100% of the length of the first sleeve.

15. Method for production of a cylinder (1) according to claim 1, characterized in that the first sleeve (20) is produced through the pultration method.

16. Method according to claim 1, characterized in that the first sleeve (20) is obtained from a long pipe produced through the pultration method, whereby the length of the first sleeve (20) is defined by sawing or an alternative method of separation.

17. Method according to claim 1, characterized in that an additional sleeve is mounted on the first sleeve (20) or the long pipe, by winding or spinning fibers on the circumferential area of the first sleeve, which fibers are embedded in a plastic matrix.

18. Cylinder according to claim 6, characterized in that the device for absorbing the torsional stress comprises at least one ring.

19. Cylinder according to claim 1, characterized in that at least one ring is arranged within the sleeve 7.

20. Cylinder according to claim 18, characterized in that at least one of the rings contains carbon fibers, which are aligned along the radial direction of the ring.

21. Cylinder according to claim 18, characterized in that at least one of the rings contains a metal.

22. Cylinder according to the preceding claim, characterized in that at least one of the rings is metal ring, preferably a steel ring.

23. Cylinder according to claim 18, characterized in that at least one of the rings has a cross sectional area, which deviates from the rectangular form.

24. Cylinder according to the preceding claim, characterized in that at least one of the rings has a unshaped profile.
